(19) United States
(12) Patent Application Publication
(10) Pub. No.: US 2013/0174434 A1
(43) Pub. Date: Jul. 11, 2013

(54) DRYING RACK FOR USE WITH A DRYER APPLIANCE

(71) Applicants: Alexander D. James, Louisville, KY (US); Richard D. Henderson, Louisville, KY (US); Thomas G. Holzen, Louisville, KY (US)

(72) Inventors: Alexander D. James, Louisville, KY (US); Richard D. Henderson, Louisville, KY (US); Thomas G. Holzen, Louisville, KY (US)

(73) Assignee: GENERAL ELECTRIC COMPANY, Schenectady, NY (US)

(21) Appl. No.: 13/347,972

(22) Filed: Jan. 11, 2012

(51) Int. Cl. F26B 11/02; F26B 25/18

(52) U.S. Cl. 34/108; 34/239

(57) ABSTRACT

A drying rack for use in a dryer appliance is provided. The drying rack is configured for selective placement in one of several positions: resting levelly on a top surface of the dryer appliance, projecting from a wall of the dryer appliance, and/or for extending into a drying chamber defined by the dryer appliance.

### FIELD OF THE INVENTION

The present subject matter relates generally to a drying rack for use with a dryer appliance.

### BACKGROUND OF THE INVENTION

Conventional dryer appliances include a drum rotatably mounted within the dryer appliance's cabinet. During operation of the dryer appliance, the drum rotates causing articles within the drum to “tumble” as the articles dry. However, certain articles, e.g., shoes and sweaters, can be damaged if they are tumbled. In order to dry such articles, many conventional dryer appliances include a drying rack that a user may selectively mount inside the drum. The drying rack includes a surface that supports the articles while they dry.

A conventional drying rack is generally directed to the specific purpose of supporting articles in the drying chamber of the dryer appliance. Due to the rack's specialized purpose, the drying rack is often oddly shaped. In turn, the rack's odd shape often makes it awkward to store. For example, when the drying rack is stored on a top of the dryer appliance, the rack may not sit level due to the rack's shape. Because the rack does not sit level, users generally cannot use the rack for other purposes such as ambient air drying or to store other items (e.g., detergent) on top of the rack when the rack is not in use. Because nothing can be easily stored on top, the racks often take up a significant amount of storage space. Storage space, particularly on top of a dryer, is often limited, so users may throw the rack away. Accordingly, a drying rack that may be stored or placed on a flat surface in a level manner would be welcome in the art in order to facilitate storage of the rack and/or other uses thereof.

In addition, certain articles should not be exposed to a dyer appliance's heated air while drying. For example, some linen clothing preferably should be allowed to air dry, e.g., on a hanger. Many consumers purchase an additional rack to support such articles as the articles are drying. However, this requires the consumer to purchase and store an additional rack.

Accordingly, a drying rack that may be stored in a level configuration and that supports articles inside and outside of the dryer appliance's drying chamber would be appreciated in the art.

### BRIEF DESCRIPTION OF THE INVENTION

Aspects and advantages of the invention will be set forth in part in the following description, or may be obvious from the description, or may be learned through practice of the invention.

In a first embodiment, a dryer appliance is provided. The dryer appliance includes a cabinet having a front panel, a top cover, and a bottom panel. The front panel extends between the top cover and the bottom panel. The front panel defines an opening for the receipt of articles for drying and a first attachment point. The first attachment point is positioned adjacent a bottom of the opening. The top cover defines a second attachment point positioned adjacent the front panel of the cabinet. The dryer appliance also includes a drum rotatably mounted within the cabinet. The drum defines a chamber for receipt of articles for drying. The dryer appliance further includes a drying rack. The drying rack has a shelf extending between a first end and a second end. The shelf also has a top side for bearing an article during drying of the article and a bottom side. The drying rack also has attachment mechanisms for selectively attaching the shelf to the dryer appliance at the first or second attachment points. The attachment mechanisms extend from the first end of the shelf. In addition, the drying rack includes a legs extending from the bottom side of the shelf. Each of the legs has a foot. The legs are positioned adjacent the first end of the shelf. The drying rack further includes struts. Each of the struts extends from the bottom side of the shelf. Each of said struts also has an end. The ends of the struts and the feet of the legs are substantially coplanar. The struts are positioned adjacent the second end of the shelf. Further, the drying rack is configured for selective placement in each of the following positions: extending from the front panel of said cabinet at the second attachment point; projecting into the chamber of said drum at the first attachment point; and resting levelly on the top cover of said cabinet.

In a second embodiment, a drying rack for a dryer appliance is provided. The dryer appliance has a cabinet with a front panel, a top cover, and a bottom panel. The front panel extends between the top cover and the bottom panel. The front panel also defines an opening. The dryer appliance also has a drum rotatably mounted within the cabinet. The drum defines a chamber for receipt of articles for drying. The opening of the front panel being positioned adjacent the drum to access the chamber of the drum. The drying rack is configured for selectively extending from the front panel of the cabinet, for selectively projecting into the chamber of the drum, and for selectively resting levelly on the top cover of the cabinet. The drying rack includes a shelf extending between a first end and a second end. The shelf has a top side for bearing an article during drying of the article and a bottom side. An attachment mechanism extends from the first end of the shelf. Legs extend from the bottom side of the shelf. Each of the legs has a foot. The legs are positioned adjacent the first end of the shelf. The drying rack also has struts. Each of the struts extends from the bottom side of the shelf. Each of said struts also has an end. The ends of the struts and the feet of the legs are substantially coplanar. The struts are positioned adjacent the second end of the shelf.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of a dryer appliance in accordance with an exemplary embodiment of the present subject matter;

FIG. 2 illustrates a perspective view of the exemplary dryer appliance of FIG. 1 in which a portion of the cabinet is cut away for purposes of revealing certain components as described below;

FIG. 3 illustrates a drying rack in accordance with an exemplary embodiment of the present subject matter;

FIG. 4 illustrates the drying rack of FIG. 3 extending from a wall of the exemplary dryer appliance of FIG. 1; and

FIG. 5 illustrates the exemplary drying rack of FIG. 3 projecting into a drying chamber of the exemplary dryer appliance of FIG. 1 and disposed on a top of the dryer appliance in a level configuration.

### DETAILED DESCRIPTION OF THE INVENTION

A drying rack for use in a dryer appliance is provided. The drying rack is configured for selective placement in one of several positions: resting levelly on a top surface of the dryer appliance, projecting from a wall of the dryer appliance, and/or for extending into a drying chamber defined by the dryer appliance. Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “article” may refer to but need not be limited to fabrics, textiles, garments (or clothing), and linens. Furthermore, the term “load” or “laundry load” refers to the combination of articles that may be washed together in a washing machine or dried together in a laundry dryer (i.e. clothes dryer) and may include a mixture of different or similar articles of different or similar types and kinds of fabrics, textiles, garments and linens within a particular laundering process.

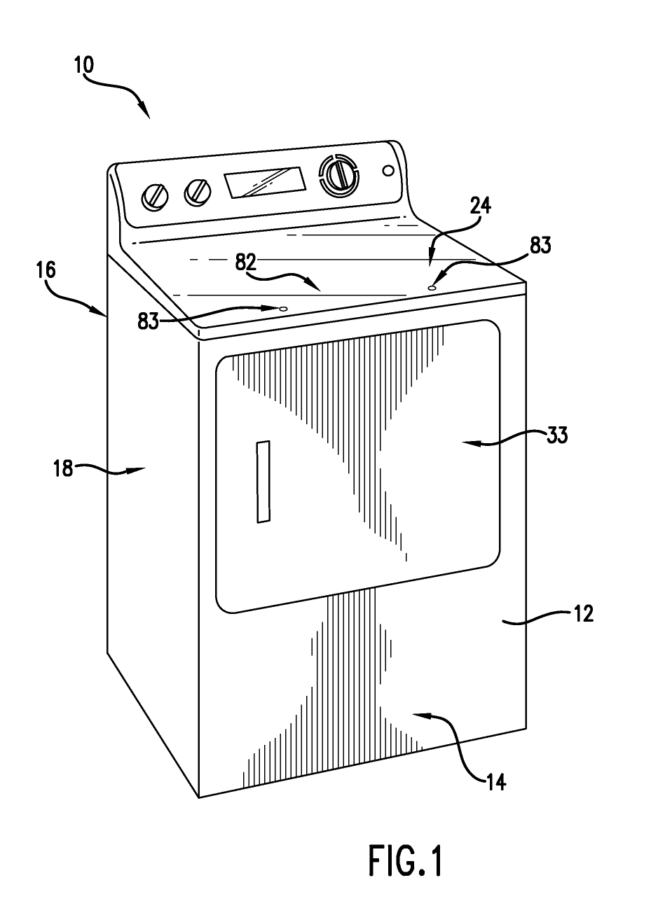

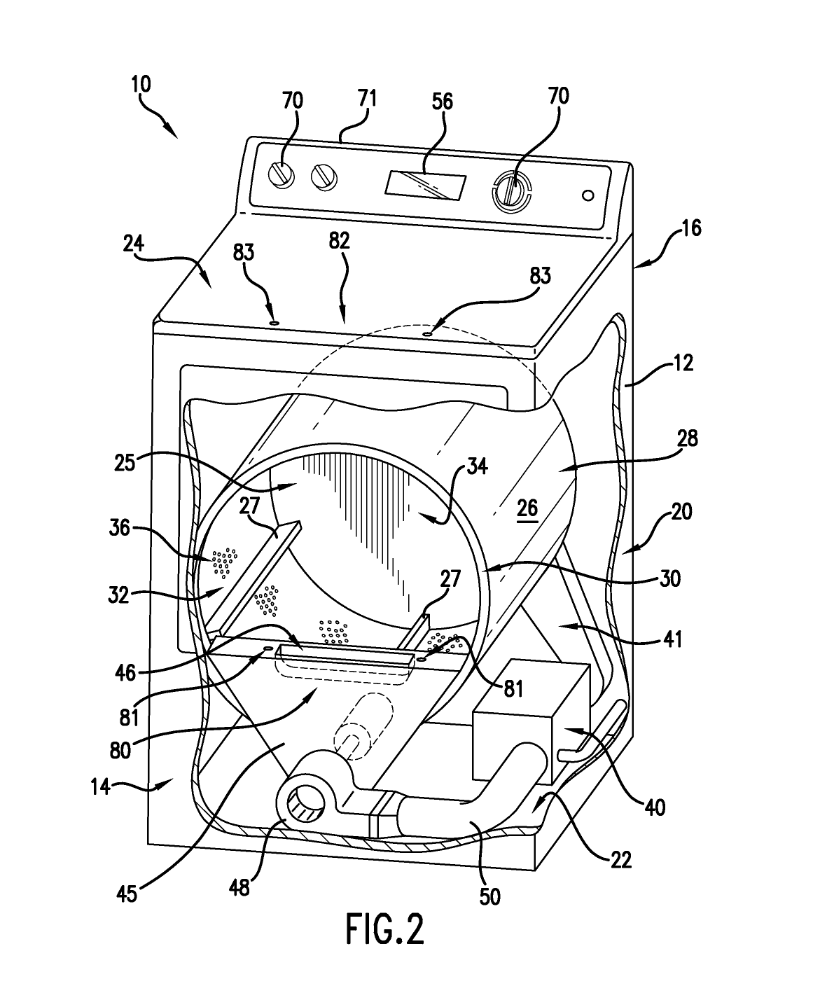

FIGS. 1 and 2 illustrate an exemplary embodiment of a dryer appliance 10 according to an embodiment of the present subject matter. However, while described in the context of a specific embodiment of the dryer appliance 10, using the teachings disclosed herein it will be understood that the dryer 10 is provided by way of example only. Other dryers having different appearances and different features may also be utilized with the present invention as well. For example, FIG. 1 illustrates a rear control dryer appliance, however, any suitable dryer appliance, e.g., a front control dryer appliance, may also be used. Thus, while dryer appliance 10 has selector knobs 70 mounted on cabinet backsplash 71, in alternative embodiments, selector knobs 70 may be mounted at any suitable location, e.g., on front panel 14.

The dryer 10 includes a cabinet or a main housing 12 having a front panel 14, a rear panel 16, sidewalls 18 and 20, a bottom panel 22, and a top cover 24. The front and rear panels 14 and 16 are spaced apart from each other by the sidewalls 18 and 20 and the bottom panel 22 and top cover 24. The front panel 14 extends between the top cover 24 and the bottom panel 22 as well as the sidewalls 18 and 20.

Within the cabinet 12 is a drum or container 26 mounted for rotation about a substantially horizontal axis. The drum 26 defines a drying chamber 25 into which clothing articles are placed for drying. A motor (not shown) rotates the drum 26 about the horizontal axis through a pulley and a belt (not shown). The drum 26 is generally cylindrical in shape, having an imperforate outer cylindrical wall 28 and a front flange or wall 30. The outer cylindrical wall 28 could also be perforated as well in other embodiments of the invention. An opening 29 is defined by the front panel 14. The opening 29 is positioned adjacent the drum 26 in order to allow a user to access the drum 26 through the front panel 14 and thus allow for loading and unloading of clothing articles and other fabrics into the drying chamber 25.

A plurality of tumbling ribs 27 are provided within the drum 26 to lift clothing articles therein and then allow them to tumble back to the bottom of the drum 26 as the drum 26 rotates. The drum 26 includes a rear wall 34 rotatably supported within the main housing 12 by a suitable fixed bearing. The rear wall 34 can be fixed or can be rotatable. The rear wall 34 includes a plurality of holes 36 that receive hot air that has been heated by a heating system 40. Air is drawn from the drum 26 by a blower fan 48. The air passes through a lint or screen filter 46 mounted to a support structure 45 which traps lint particles. As the air passes from the blower fan 48, it enters a duct 50 and then is passed into the heating system 40. Heated air exits the heating system 40 and returns to the drum 26 by the duct 41. After the clothing articles have been dried, they are removed from the drum 26 via the opening 32. A door 33 mounted adjacent the opening 32 provides for closing or accessing the drum 26.

A cycle selector knob 70 is mounted on a cabinet backsplash 71 and is in communication with a processing device or controller connected with a user display panel 56. Signals generated in the controller operate the drum drive system and heating system 40 in response to the user manipulation of the selector knobs 70. Alternatively, a touch screen type interface may be provided. As used herein, “processing device” or “controller” may refer to one or more microprocessors or semiconductor devices and is not restricted necessarily to a single element. The processing device can be programmed to operate the dryer 10 according to methods well known in the art. The processing device may include, or be associated with, one or memory elements such as e.g., electrically erasable, programmable read only memory (EEPROM).

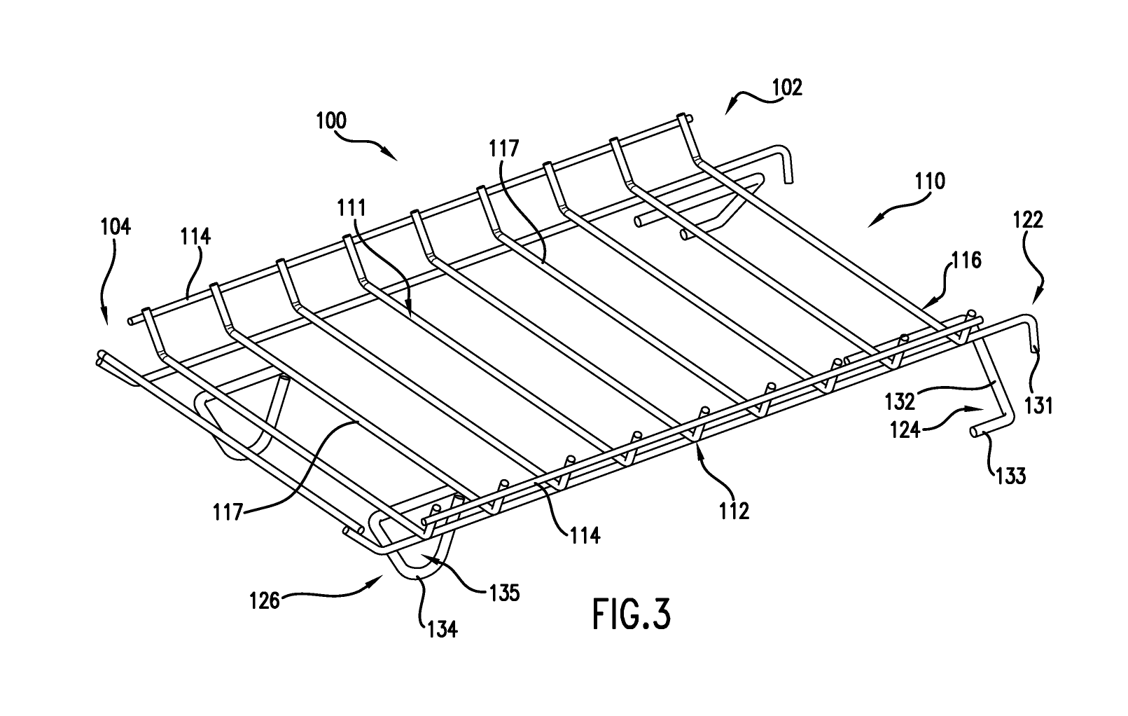

FIG. 3 illustrates an exemplary drying rack 100 for use with, e.g., the exemplary dryer appliance 10 of FIGS. 1 and 2. As may be seen in FIG. 3, the drying rack 10 includes a shelf 110. The shelf 110 extends between a first end 102 and a second end 104. The shelf 110 has a top side 111 for bearing an article during drying of the article. The shelf 110 also has a bottom side 112. The bottom side 112 may be substantially parallel to the top side 111. In addition, the shelf 110 includes a band 114 that assists in supporting articles on the shelf 110 by impeding the articles from sliding off or moving on the shelf 110.

In FIG. 3, the shelf 110 has a plurality of elongated members 117 that are spaced apart and cooperate to support items on the shelf 110 (e.g., the plurality of elongated members 117 may comprise a wire rack). However, in alternative embodiments, the shelf 110 may have a solid surface that supports articles on the shelf 110. In addition, the shelf 110 may be constructed of, e.g., metal, plastic, metal and plastic, or any other suitable material or combination of materials.

As may be seen in FIG. 3, the shelf 110 has attachment mechanisms 122, legs 124, and struts 126. The attachment mechanisms 122 extend from an edge 116 of the shelf 110 adjacent a first end 102 of the drying rack. In the embodiment shown in FIG. 3, the attachment mechanisms 122 include a pair of hooks 131. However, as will be understood by one having skill in the art, the attachment mechanisms 122 may also include, e.g., snaps, clips, slots, bolts, screws, magnets, or any other suitable fastener or combination of fasteners. Thus, while described in the context of a specific embodiment of the drying rack 100, using the teachings disclosed herein a person of ordinary skill in the art will understood that the attachment mechanisms 122 in the specific embodiment is provided by way of example only.

The legs 124 of the drying rack 100 extend from the bottom side 112 of the shelf 110 adjacent the first end 102 of the shelf 110. In FIG. 3, the legs 125 have a wall portion 132 that extends between the bottom side 112 of the shelf 110 and a foot 133 of the legs 125. The struts 126 of the drying rack 100 extend from the bottom side 112 of the shelf 110 adjacent the second end 104 of the shelf 110. Each of the struts 126 has an end 134. In FIG. 3, each of the struts 126 has an elongated member in the form of a loop such that the elongated member defines an opening 135. The ends 134 of the struts 126 and the feet 133 of the legs 124 extend away from the bottom side 112 of the shelf 110 by about the same amount of distance. Thus, the ends 134 of the struts 126 and the feet 133 of the legs 124 are substantially coplanar.

It should be understood that the attachment mechanisms 122, legs 124, and the struts 126 may have any suitable configuration that permits the attachment mechanisms 122, legs 125, and the struts 126 to function in the manner described herein. Thus, for example, the attachment mechanisms 122, the legs 125, and the struts 126 may have any suitable configuration that allows the attachment mechanisms 122, the legs 125, and the struts 126 to selectively support the shelf 110 levelly on the top cover 24 of the dryer appliance 10, selectively project the shelf 110 from the sidewalls 18,20 or the front panel 14 of the dryer appliance 10, or selectively extend the shelf 110 into the drying chamber 25 defined by the dryer appliance 10.

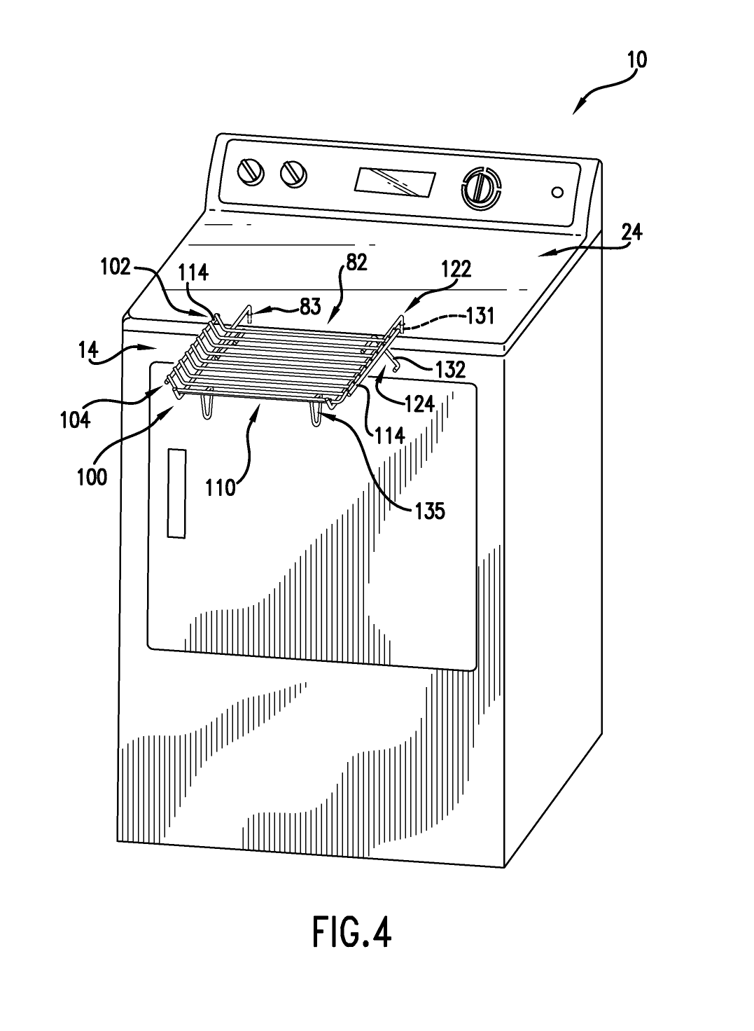

FIG. 4 illustrates the exemplary drying rack 100 of FIG. 3 extending from the front panel 14 of the exemplary dryer appliance 10 of FIG. 1. In FIG. 4, the drying rack 100 is in an extended configuration. In the extended configuration, the shelf 110 of the drying rack 100 is supported by the attachment mechanisms 122 and the legs 124. The attachment mechanisms 122 are positioned adjacent a second attachment point 82. In FIG. 4, the second attachment point 82 is a second pair of holes 83 defined in the top cover 24 of the dryer appliance 10 adjacent the front panel 14 of the cabinet 12. Each of the pair of hooks 131 of the attachment mechanisms 122 is disposed within a respective one of the second pair of holes 83. The wall portion 132 of the legs 124 is adjacent the front panel 14 of the dryer appliance 10. Thus, the attachment mechanisms 122 and legs 124 cooperate to extend or cantilever the shelf 110 away from the front panel 14 of the dryer appliance 10 in the extended configuration.

By extending the shelf 110 away from the dryer appliance 10, the shelf 110 may be used to support articles on hangers. For example, a tip of a hanger may be inserted through the opening 135 formed by the loop shape of one of the struts 126. The hanger may then hang from the loop, e.g., while the article supported by the hanger dries. In addition, the hanger may also hang from the shelf 110, e.g., from the band 114 of the shelf 110.

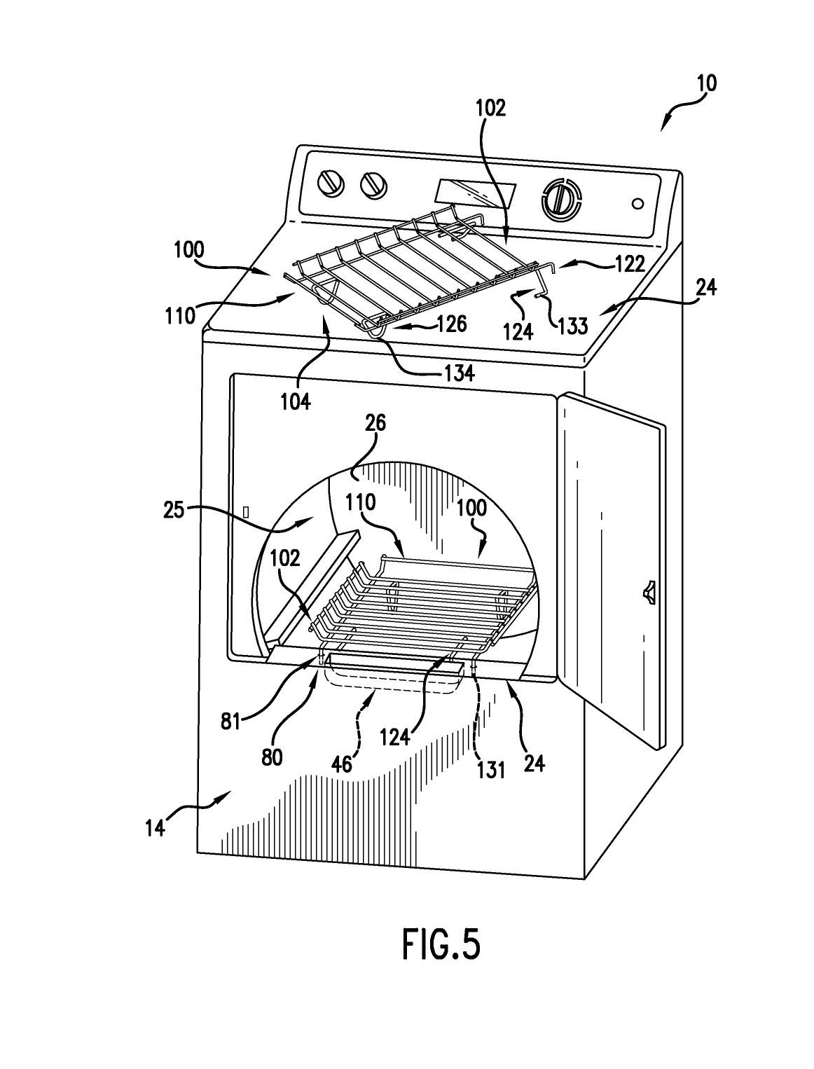

FIG. 5 illustrates the exemplary drying rack 100 of FIG. 3 in two alternative configurations. In FIG. 5, the drying rack 100 is projecting into the drying chamber 25 defined by the drum 26 of the dryer appliance 10 of FIG. 1, and the drying rack 100 also rests levelly on the top cover 24 of the dryer appliance 100. In the former, the drying rack 100 is in a projected configuration. While, in the latter, the drying rack 100 is in a level configuration.

In the projected configuration, the shelf 110 of the drying rack 100 is supported by the attachment mechanisms 122 and the legs 124. The attachment mechanisms 122 are positioned adjacent a first attachment point 80. In FIG. 5, the first attachment point 80 is a first pair of holes 81 defined in the front panel 14 of the dryer appliance 10 adjacent a bottom 29 of the opening 25 of the front panel 14. Each of the hooks 131 is disposed within a respective one of the first pair of holes 81. The wall portion 132 of the legs 124 is adjacent the front panel 14 of the dryer appliance 10 (e.g., positioned adjacent the lint filter 46 of the dryer appliance 10). Thus, the attachment mechanisms 122 and legs 124 cooperate to project or cantilever the shelf 110 into the drying chamber 25 defined by the drum 26 of the dryer appliance 100 in the projected configuration. By projecting the shelf 110 into the drying chamber 25, the shelf 110 may be used to support articles in the drying chamber 25 (e.g., shoes or sweaters) that should not be tumbled during drying.

FIG. 5 also illustrates the exemplary drying rack 100 of FIG. 3 disposed on the top cover 24 of the dryer appliance 100 in a level configuration. In the level configuration, the shelf 110 of the drying rack 100 is supported by the legs 124 and the struts 126. In the level configuration, the foot 133 of the legs 124 and the end 134 of the struts 126 are positioned adjacent the top cover 24 of the dryer appliance. As may be seen in FIG. 5, because the feet 133 of the legs 124 and the ends 134 of the struts 126 extend form the bottom side 112 of the shelf 110 by about the same distance, the shelf 110 is substantially level relative to the top cover 24 in the level configuration. Thus, the legs 124 and struts 126 cooperate to level the shelf 110 relative to the top cover 24 of the dryer appliance 10 when the drying rack 100 is in the level configuration. By leveling the shelf 110, the shelf 110 may be used to support articles on the top surface 24 of the dryer appliance 10, e.g., shoes or sweaters. In addition, when in the level configuration, the drying rack 100 may be used to store other items, e.g., detergent, laundry baskets, or any other suitable items or combination of items.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dryer appliance, comprising:
a cabinet having a front panel, a top cover, and a bottom panel, the front panel extending between the top cover and the bottom panel, the front panel defining an opening for the receipt of articles for drying and a first attachment point, the first attachment point being positioned adjacent a bottom of the opening, said cabinet also defining a second attachment point positioned adjacent the front panel of said cabinet;
a drum rotatably mounted within the cabinet, said drum defining a chamber for receipt of articles for drying; and
a drying rack comprising:
a shelf having a first end and a second end, said shelf having a top side for bearing an article during drying of the article, said shelf also having a bottom side;
an attachment mechanism for selectively attaching said shelf to the dryer appliance at the first or second attachment points, the attachment mechanism extending from the first end of said shelf;
a plurality of legs extending from the bottom side of said shelf, each of said legs having a foot, said legs positioned adjacent the first end of said shelf; and
a plurality of struts, each of said struts extending from the bottom side of said shelf, each of said struts having an end, the ends of said struts and the feet of said legs being in substantially the same plane so that said drying rack can sit level, said struts positioned adjacent the second end of said shelf;
wherein said drying rack is configured for selective placement in each of the following plurality of positions:
i) extending outwardly from the front panel of said cabinet at the second attachment point;
ii) projecting into the chamber of said drum at the first attachment point; and
iii) resting levelly on the top cover of said cabinet.

2. The dryer appliance of claim 1, wherein the feet of said legs and the ends of said struts are positioned adjacent the top cover of said cabinet, and said shelf is substantially level.

3. The dryer appliance of claim 1, wherein said legs are positioned adjacent the front panel of said cabinet and the attachment mechanism is adjacent the second attachment point of said cabinet, and said shelf extends from the front panel of said cabinet.

4. The dryer appliance of claim 1, wherein said legs are positioned adjacent the front panel of said cabinet and the attachment mechanism is adjacent the first attachment point of said support structure, and said shelf projects into the chamber of said drum.

5. The dryer appliance of claim 4, wherein the first end of said shelf is adjacent a lint filter.

6. The dryer appliance of claim 1, wherein said attachment mechanism is a pair of hooks.

7. The dryer appliance of claim 6, wherein said first and second attachment points comprise holes defined in the top cover of said cabinet and the front panel of said cabinet respectively.

8. The dryer appliance of claim 1, wherein said attachment mechanism comprises a magnet.

9. The dryer appliance of claim 1, wherein said attachment mechanism is a pair of screws.

10. The dryer appliance of claim 9, wherein said first and second attachment points comprise holes defined in the top cover of said cabinet and the front panel of said cabinet respectively.

11. The dryer appliance of claim 1, wherein each one of said struts forms a loop.

12. The dryer appliance of claim 1, wherein said shelf has a plurality of elongated members.

13. A drying rack for a dryer appliance, the dryer appliance having a cabinet with a front panel, a top cover, and a bottom panel, the front panel extending between the top cover and the bottom panel, the front panel defining an opening, the dryer appliance also having a drum rotatably mounted within the cabinet, said drum defining a chamber for receipt of articles for drying, the opening of the front panel being positioned adjacent the drum to access the chamber of said drum, the drying rack configured for selectively extending from the front panel of said cabinet, for selectively projecting into the chamber of said drum, and for selectively resting levelly on the top cover of said cabinet, the drying rack comprising:
a shelf extending between a first end and a second end, said shelf having a top side for bearing an article during drying of the article, said shelf also having a bottom side;
an attachment mechanism extending from the first end of said shelf;
a plurality of legs extending from the bottom side of said shelf, each of said legs having a foot, said legs positioned adjacent the first end of said shelf; and
a plurality of struts, each of said struts extending from the bottom side of said shelf, each of said struts having an end, the ends of said struts and the feet of said legs being substantially coplanar, said struts positioned adjacent the second end of said shelf.

14. The dryer appliance of claim 13, wherein said attachment mechanism is a pair of hooks.

15. The dryer appliance of claim 13, wherein said attachment mechanism is a magnet.

16. The dryer appliance of claim 13, wherein said attachment mechanism is a pair of screws.

17. The dryer appliance of claim 13, wherein each one of said struts forms a loop.

18. The dryer appliance of claim 13, wherein said shelf has a plurality of elongated members.
